(19) United States
(12) Patent Application Publication
(10) Pub. No.: US 2021/0031257 A1
(43) Pub. Date: Feb. 4, 2021

(54) METHOD FOR PRODUCING A CASTING MOLD FOR FILLING WITH MELT AND CASTING MOLD

(71) Applicants: SCHUBERT & SALZER FEINGUSS LOBENSTEIN GMBH, BAD LOBENSTEIN (DE); LITHOZ GMBH, WIEN (AT)

(72) Inventors: JOHANNES HOMA, WIEN (AT); MANFRED SPITZBART, WIEN (AT); DOMINIK REICHARTZEDER, WIEN (AT); PETER SCHNEIDER, WIEN (AT); BERTRAM KAWLATH, NUERNBERG (DE); ARMIN RAAB, SELB (DE); HOLGER REICHENBAECHER, LEUTENBERG (DE)

(21) Appl. No.: 16/982,809

(22) PCT Filed: Mar. 20, 2019
(86) PCT No.: PCT/EP2019/056987

§ 371 Date: Sep. 21, 2020

(30) Foreign Application Priority Data
Mar. 21, 2018 (DE) 10 2018 106 725.9
Jun. 22, 2018 (DE) 10 2018 115 087.3

(51) Int. Cl. B22C 9/02

(52) U.S. Cl. CPC B22C 9/02; B33Y 80/00

(57) ABSTRACT

A method for producing a casting mould for filling with melt and/or a core for producing a hollow space in a cast part, includes forming a wall made of a refractory and gas-permeable material. The wall is formed to include an inner wall and a support structure built up in successive layers against the inner wall. The inner wall is formed with an inner surface defining a roughness matching the surface roughness of the part that is to be cast in the mould. A generative manufacturing method generates the successive layers of the support structure, which includes open and/or closed hollow spaces and/or different thicknesses of the successive layers of the support structure that supports the casting mould independently against the casting pressure in a dimensionally stable manner and also isolates or dissipates thermal energy in the melt in a targeted manner.

### CROSS-REFERENCE TO RELATED APPLICATIONS

This application is a continuation of copending International Application No. PCT/EP2019/056987, filed Mar. 20, 2019, which is hereby incorporated herein by this reference in its entirety for all purposes.

### FIELD OF THE INVENTION

The present invention relates to a method for producing a casting mould, in particular a shell, for filling with melt and/or a core for producing a hollow space in a cast part, comprising a wall made of a refractory and gas-permeable material, wherein the casting mould is built up with the aid of a generative manufacturing method, and a corresponding casting mould.

### BACKGROUND OF THE INVENTION

DE 103 17 473 B3, which corresponds to U.S. Patent Application Publication No. 2004-0216860 that is hereby incorporated herein by this reference for all purposes, makes known a casting mould for the metal casting or precision casting of precision components, wherein the substantial portion of the casting mould consists of a porous ceramic, which is in the green or sintered condition and is produced with the aid of a generative rapid prototyping method. Examples of generative rapid prototyping methods are described in US Patent Publication Nos. 2017-0106595 and 2018-0071978 and U.S. Pat. No. 10,343,301, which are hereby incorporated herein by this reference for all purposes. The structures corresponding to the mould cores or the structures around which metal will flow are produced with the aid of a generative rapid prototyping method. The external shape of the casting mould can also be produced with the aid of the rapid prototyping method. For example, cooling ducts are provided or risers are formed or external ribs, which act as cooling ducts, are arranged on or in the outer side of the casting mould. Moreover, it is described that support ribs can be provided, which are arranged on the side facing away from a cavity. In order to withstand the pressure, the casting mould is back-lined with a filling of loose ceramic. The filling provides the comparatively thin casting mould, which is produced with the aid of a generative rapid prototyping method, the mechanical stability required for casting. Alternatively, a shell is provided, into which the casting mould is placed, in order to be able to withstand the pressure during casting.

It is disadvantageous in this case that the casting mould must be accommodated in a container in order to receive the filling, so that the filling with loose ceramic can sufficiently support the casting mould. This requires additional material as well as manual interventions and, therefore, results in a time-consuming and cost-intensive method. The same also applies in the alternative embodiment comprising a shell. In addition, the heat dissipation of the freshly cast casting cannot be affected, since the filling and the shell further insulate the casting mould.

### SUMMARY OF THE INVENTION

The problem addressed by the present invention is that of creating a casting mould as well as a method for producing a casting mould, with the aid of which a casting mould can be produced in a largely automated manner, which can withstand the casting pressure itself and without further measures and, therefore, can be created cost-effectively and quickly, and can dissipate the heat arising during casting in a targeted manner, i.e., depending on the desired cooling time of individual areas of the casting and, therefore, also increases the quality of the casting.

The problem is solved with the aid of a method and a casting mould according to the description that follows.

According to the method according to the invention for producing a casting mould, in particular a shell, for filling with melt and/or a core for producing a hollow space in a cast part, a wall is made of a refractory and gas-permeable material, for example, ceramic. The casting mould is built up with the aid of a generative manufacturing method. Generative manufacturing methods of this type are, for example, 3D printing methods, in which liquid material is applied layer by layer and is subsequently cured. According to the invention, the wall of the casting mould is formed comprising a support structure especially designed for the casting mould and formed by open and/or closed hollow spaces and/or which has different wall thicknesses, in order to support the casting mould largely independently against the casting pressure in a dimensionally stable manner and also to isolate thermal energy in the melt or dissipate it from the melt in a targeted manner. Due to the support structure, which is preferably integrally connected to the wall of the casting mould, a stable casting mould is created, which is suitable for casting highly precise cast parts. In addition, a casting mould, which can be produced in a largely automated manner, is made possible with the aid of this manufacturing method. The automation takes place up to immediately before the material is cast into the casting mould. No further support measures are necessary, such as filling hollow spaces with sand or other materials, since the casting mould itself is already sufficiently stable to withstand the casting pressure. Due to the support structure, it is also made possible that the heat of the melt arising during casting is retained or dissipated in a targeted manner, in order to obtain an optimally cooled casting.

The casting mould according to the invention is provided, in particular, for metal, industrial precision casting. A plurality of casting moulds is created, wherein it is particularly economical when these casting moulds can be created quickly and in an automated manner. The entire mould or only a portion thereof can be produced with the support structure. Simple moulds without a core or more complicated moulds comprising one or multiple cores (core-shell moulds) can be produced.

In contrast to a conventional precision casting method, which is usually implemented with the aid of an investment casting method, the production with the aid of the method according to the invention is possible in a substantially more economical manner. In the conventional investment casting method, a wax model is namely first produced, which is connected together with further wax models to form a casting unit. This casting unit made of wax is then dipped into liquid ceramic and sanded. This process is repeated multiple times until a sufficiently thick and stable shell mould has formed. Thereafter, the wax is melted out of the shell mould and the shell mould is fired. Only then can the casting of a part be continued.

In the method according to the invention, on the other hand, the production of a wax model as well as the assembly of a casting unit made of wax and the dipping and sanding in order to obtain the shell mould are dispensed with. Rather, in the method according to the invention, the shell mould is created directly with the aid of the generative manufacturing method. In this way, either the casting mould alone or even the individual casting mould together with a gating system and further casting moulds, which are connected to the gating system, are produced. In order to be able to implement a wall thickness that is nevertheless capable of withstanding the casting pressure to be anticipated, the support structures are provided, which can support and stabilize the cavity in a more or less stable manner, according to demand. Due to the structured configuration of the support structure, it is possible that the support structure is designed to be more stable in areas, in which a higher casting pressure is to be anticipated, and is configured and produced in a simpler and less stable manner in areas, in which the casting pressure will be lower. Therefore, the production of the casting mould can also take place in a highly economical manner, since the material usage—and, therefore, the production time, which, due to the generative method, is dependent to a certain extent on the amount of walls and support structures to be produced—can be matched to the present requirements in a targeted manner. In addition, the cooling of the fresh casting can be affected by the support structure. More hollow spaces, in particular closed hollow spaces, insulate the casting for a longer time and more material of the support structure can accelerate the heat dissipation. In this way, for example, a uniformly cooling component can be created or individual areas of the casting can be kept warm for a longer time. A casting free from stress and shrinkage cavities can therefore be produced. Open structures support the heat dissipation. Even cooling ducts, through which air is blown, are conceivable. In particular in the embodiment of the cooling ducts, there are great freedoms with respect to the present invention as compared to conventional productions.

One further advantage of the invention as compared to a back-lined mould as in DE 103 17 473 B3 is that the amount of energy utilized to fire a back-lined mould is many times higher than in the case of a mould comprising a support structure. This has effects on throughput times and production costs, first and foremost, in a serial production.

A 3D printing method, with the aid of which the casting mould is built up layer by layer, is particularly advantageous as a generative manufacturing method. In order to be able to produce a particularly precise casting mould, it is advantageous when the individual layers transition into one another as seamlessly as possible and, therefore, make a uniform structure possible. This is advantageous, in particular, in the area of the inner side of the casting mould facing the cavity.

According to one advantageous embodiment of the invention, the generative manufacturing method is slurry-based, in particular carried out as stereolithography, using digital light processing technology (DLP), as direct inkjet writing (DIW), or using slipcasting-based technology, for example, with the aid of layer-wise slurry deposition (LSD) or LIS. Therefore, the casting mould can be produced in good quality, in particular with low roughness and at sufficient speed.

If the support structure is arranged at the outer side of the casting mould facing away from the future casting or the cavity, the cavity in which the cast part is to be subsequently cast is not affected by the support structure according to the invention. The manufacturing method according to the invention namely has no effect, in principle, on a certain design of the cast parts and, therefore, is universally usable. The support structure is based on the cast part to be produced, and the cast part does not need to be adapted to the support structure.

In one advantageous embodiment of the invention, if the support structure is designed to be coarser from the inner side facing the future casting toward the outer side of the casting mould facing away from the future casting, an optimal design can take place with the least amount of material for the support structure. The coarser embodiment of the support structure can be implemented, in particular, with the aid of hollow spaces that become larger from the inside toward the outside, and are open and/or closed. While smaller hollow spaces are provided close to the cavity, larger hollow spaces are advantageous as the distance from the cavity increases. The support effect is therefore generated in an optimal manner, without the need to utilize a large amount of material for the support structure. In addition, the heat dissipation can be affected in a targeted manner by way of this design.

If multiple identical or different casting moulds are connected to the gating system in an aciniform manner, then, similarly to the conventional investment casting method, an aciniform casting unit can be created, with which a plurality of parts can be produced in one casting. This also results in an economical method for producing the parts.

If a surface structure having very low roughness is formed at the inner side of the wall of the casting mould, it is ensured that a particularly smooth part can be produced. The very low roughness Rz is preferably less than 100 μm, which is generally sufficient for achieving an appropriate surface quality of the part.

The method according to the invention is very particularly advantageously suitable for a precision casting method. In the precision casting method, the casting mould can be particularly economically produced and utilized, since precision casting methods are generally utilized industrially and a relatively large number of individual cast parts is to be produced in a short time. In addition, these industrially produced precision castings are also very sensitive in terms of price, and so highly cost-effective precision castings are to be created with the aid of the method according to the invention.

If, advantageously, the casting mould is utilized for a single-crystal casting, turbine blades can be very effectively produced, for example.

Preferably, the shape of the support structure is configured in an optimized manner with respect to the mechanical and/or thermal load(s) to be anticipated during the casting operation. Therefore, depending on the wall thickness or hollow spaces of the casting to be cast, it can be brought about, for example, that the solidification of the metal takes place in a uniform manner. The necessary wall thickness, arrangement and size of the individual elements, such as the ribs, are calculated and adapted to the requirements.

A casting mould according to the invention, in particular a shell, for filling with melt and/or a core for producing a hollow space in a cast part, comprising a wall made of a refractory and gas-permeable material, in particular ceramic, is built up with the aid of a generative manufacturing method. According to the invention, the wall of the casting mould comprises a support structure especially designed for the casting mould and formed by open and/or closed hollow spaces and/or by different wall thicknesses. The support structure is provided in order to support the casting mould largely independently against the casting pressure in a dimensionally stable manner and also to isolate thermal energy in the melt or dissipate it from the melt in a targeted manner. With the aid of the support structure, the entire mould or a portion thereof can be formed. Simple moulds without a core or more complicated moulds comprising one or multiple cores (core-shell moulds) can be produced.

Due to the support structure, it is now possible that a casting mould is created, which makes it possible to cast a highly precise part. The casting mould does not change its shape due to the casting pressure of the melt, since the support structure is designed in such a way that it supports the casting mould, into which the melt is filled, in such a way that it cannot deform. With the aid of the casting mould according to the invention, therefore, a highly precise casting mould and, therefore, also the creation of a highly precise cast part are made possible.

Due to the support structure, the manner in which the thermal energy can be isolated in the melt or can be dissipated from the melt can also be affected. For a highly precise part, it is crucial that the thermal energy of the melt be dissipated in a targeted manner. There can be areas, in which it is advantageous when the heat is retained for as long as possible and, on the other hand, there will be areas, in which it is advantageous that the heat is dissipated as quickly as possible. Due to an appropriate arrangement of the support structure, which is especially designed to the individual casting mould, a retention or a dissipation of the heat of the melt can be affected in a highly targeted manner. The casting mould according to the invention therefore allows not only for the production of a precise component, but rather also technically an exceptional effect on the heat dissipation, in order to create a precise and flawless cast part.

The casting mould is preferably a precision casting mould. A highly precise production of the part is necessary particularly with respect to precision casting, which is carried out industrially. Due to the above-described advantages of the casting mould according to the invention, the casting mould can therefore be very particularly advantageously utilized in the precision casting method.

If the casting mould has an inner side facing the future cast part and an outer side facing away from the future cast part, wherein a negative mould of the part to be cast is formed in the form of a cavity at the inner side of the casting mould and the support structure is arranged at the outer side, i.e., at the side of the wall of the casting mould facing away from the cavity, a casting mould can be created, which makes a part possible that is independent of the configuration of the support structure of the casting mould. Once the support structure is arranged at the outer side and not at the inner side of the casting mould, i.e., in the area of the cavity of the casting mould, the support structure can be arranged independently of the cavity. Therefore, a particularly great amount of design freedom is created, which the support structure optimally makes possible for the support of the casting mould against the casting pressure as well as for a targeted thermal conduction.

If multiple identical or different casting moulds are connected to a gating system in an aciniform manner, multiple parts can be simultaneously cast.

It is very particularly advantageous when the casting mould is built up layer by layer with the aid of 3D printing. As a result, a particularly great amount of design freedom of the casting mould is made possible. Undercuts of the support structure can therefore be readily implemented. The support structure or the structure for dissipating the heat or for retaining the heat can therefore be individually and particularly effectively configured for each casting mould.

Preferably, the support structure is designed to be coarser from the inner side toward the outer side of the casting mould. This means, increasingly larger hollow spaces are provided, in particular, from the inner side toward the outer side of the casting mould. While small hollow spaces or a large amount of material can advantageously effectuate support and thermal conduction in the area of the cavity, it is generally sufficient when fewer support structures are provided further away from the cavity and, therefore, larger hollow spaces are provided. This can take place with the aid of an appropriate configuration of the support structure itself as well as with the aid of a reduction of the wall thickness, and so a greater wall thickness is provided in the proximity of the cavity and a lesser wall thickness of the support structure is implemented further away from the cavity.

It is very particularly advantageous when the hollow spaces are designed to be rounded and/or angular, according to demand. Due to the generative manufacturing method, there is a very large amount of design freedom. For example, the hollow spaces can be designed to be rounded, in order to effect particularly great stability of the support structures. The angular design of the hollow spaces can be advantageous when a simple design of the support structure is desired. The hollow spaces can be designed, in particular, in the form of pores, i.e., spherically or irregularly shaped hollow spaces, honeycombs, and/or rectangular-shaped hollow spaces. Depending on the requirements on the support force or the thermal conductivity, such a shape can prove to be particularly advantageous. Of course, other shapes of the hollow spaces are also possible and can have advantages for the corresponding casting mould.

It is frequently advantageous when the support structure is formed comprising wall thicknesses that become thinner from the inner side toward the outer side of the casting mould. Thinner wall thicknesses can generally be produced more quickly, and so an even more cost-effective casting mould can be produced due to a design freedom of this type.

If a surface structure having a very low roughness is formed at the inner side of the casting mould, a cast part can be cast with the aid of the casting mould, which has a very smooth and precise surface. A very low roughness is a roughness Rz of less than 100 μm.

The wall thickness of the casting mould, i.e., the complete wall comprising the support structure or an individual support wall of the support structure, can be between 0.1 mm and 75 mm. In particular, the individual wall thickness of the support wall can be designed to be very thin, for example, 0.1 mm, although it can also have a wall thickness of several millimeters. The entire wall structure of the casting mould, including the support structure, can also be several millimeters, up to 75 mm, depending on the size of the part to be cast. A greater wall thickness becomes necessary, in particular, when the wall thickness is also to be suitable for creating a connection to the gating system.

According to one advantageous embodiment of the invention, the casting mould is a single-crystal casting mould for casting single-crystal castings. Therefore, for example, turbine blades can be very effectively produced.

The casting mould is preferably produced with the aid of a slurry-based generative manufacturing method. Therefore, the casting mould can be produced in good quality, in particular with low roughness and at sufficient speed.

### BRIEF DESCRIPTION OF THE DRAWINGS

Further advantages of the invention are described in the following exemplary embodiments. Wherein:

FIG. 1 shows a cross section of a system comprising multiple casting moulds,

FIG. 2 shows a detail A from FIG. 1 of a wall comprising a rhomboidal support structure,

FIG. 3 shows a detail A from FIG. 1 of a wall comprising a rectangular-shaped support structure,

FIG. 4 shows a detail A from FIG. 1 of a wall comprising a honeycomb-shaped support structure,

FIG. 5 shows a detail A from FIG. 1 of a wall comprising a support structure including circular hollow spaces,

FIG. 6 shows a detail A from FIG. 1 of a wall comprising a rib-shaped support structure, and

FIG. 7 shows a casting mould comprising a core.

### DETAILED DESCRIPTION OF EXEMPLARY EMBODIMENTS

In the following description of the represented alternative exemplary embodiments, the same reference signs are utilized for features that are identical or at least comparable in terms of their configuration and/or mode of operation. Provided the features are not described in detail again, their design and/or mode of operation correspond/corresponds to the design and mode of operation of the above-described features.

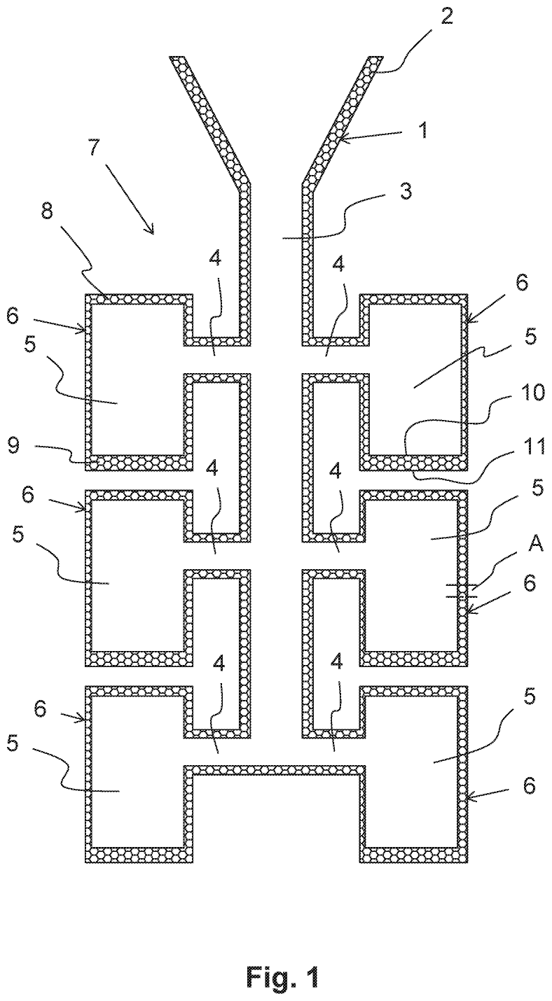

In FIG. 1, a cross section of a gating system 1 is represented in an outlined manner. The gating system 1 comprises a pouring cup 2, which opens into a downsprue 3. Starting from the downsprue 3, multiple sprues 4 extend and open into the cavity 5 of individual casting moulds 6. A melt that is poured into the pouring cup 2 therefore flows through the downsprue 3 and via the inlet openings into the cavity 5. There, the melt solidifies and forms a cast part, which assumes the shape of the cavity 5.

The combination of the gating system 1 and the casting moulds 6 is referred to as a shell mould 7. In the prior art, this shell mould 7 was produced with the aid of a wax model, which was dipped into liquid ceramic and into sand multiple times. Thereafter, this crude shell mould 7 was dried and fired, whereby a solid shell mould 7 was formed, which was suitable for filling with melt.

According to the present invention, the casting moulds 6 comprise walls 8 including a support structure 9, which have been produced with the aid of a generative manufacturing method, for example, 3D printing. In the representation from FIG. 1, the support structure 9 is represented in an outlined manner as a honeycomb-shaped crosshatching. The support structure 9 extends, in this case, not only across the casting moulds 6, but also across the gating system 1 comprising the pouring cup 2, the downsprue 3, and the sprues 4. Alternatively, it is also possible that the pouring cup 2 and/or the downsprue 3 have/has not been produced comprising a honeycomb structure or support structure 9 of this type, but rather has been created in a conventional manner or in another, simple manner.

The shell mould 7 is designed in such a way that multiple—six, in this case—casting moulds 6 are arranged in an aciniform manner at the gating system 1. It is therefore also possible that six cast parts are simultaneously cast into the six cavities 5 in one casting.

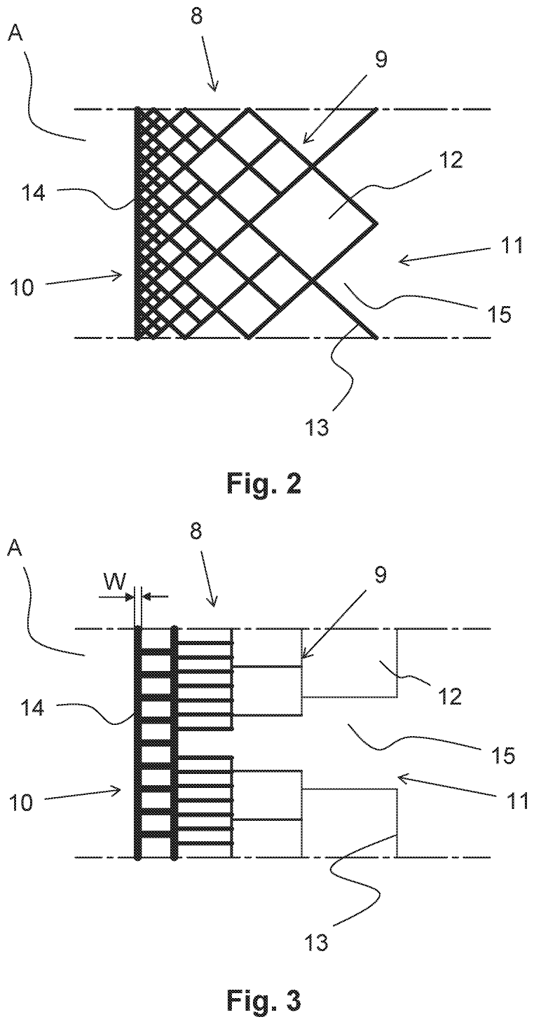

Each wall 8 comprises an inner side 10 and an outer side 11. The inner side 10 is directed into the interior of the cavity 5, while the outer side 11 simultaneously forms the outer side of the shell mould 7. Different structures of the walls 8 comprising the support structures 9 are represented, enlarged, in FIGS. 2 through 6 according to detail A.

FIG. 2 shows a detail A of the wall 8 of the casting mould 6 comprising a support structure 9, in which closed hollow spaces 12 are arranged. The support structure 9 is designed comprising a plurality of support walls 13. The support walls 13 form different-sized hollow spaces 12 having a square cross section. The hollow spaces 12 in the proximity of the inner side 10 are designed to be smaller than in the area of the outer side 11 of the wall 8.

The support walls 13 extend obliquely with respect to the inner side 10, and so the square hollow spaces 12 point toward the inner side 10 or the outer side 11 via a tip, in the manner of a rhomboid. Therefore, a particularly good support effect of the support walls 13 is effectuated for the wall 8 of the casting mould 6. While the support structure 9 forms serrated, open hollow spaces 15 in the direction toward the outer side 11, it is smoothly closed by an inner wall 14 in the area of the inner side 10. The inner wall 14 subsequently forms the surface of the part that was cast in the cavity 5. Accordingly, it is important that the inner wall 14 forms a surface structure having a very low roughness, in order to achieve a surface of the part that is as smooth as possible. The inner side 10 or the inner wall 14 is therefore preferably formed having a roughness of less than 100 μm. In addition, it is to be observed that, in the case of the layer-by-layer build-up of the wall 8 with the aid of the generative manufacturing method, in particular with the aid of 3D printing, no or only a few steppings and groove patterns are produced, which could result in a reduction in the quality of the cast part.

One further embodiment of a wall 9 of the casting mould according to detail A is represented in FIG. 3. In this case, the support structure 9 of the wall 8 is formed with the aid of hollow spaces 12 and 15 having a rectangular cross section. Most of the hollow spaces are closed hollow spaces 12. One open hollow space 15 is also provided, however. Due to the combination of the closed and open hollow spaces 12 and 15, respectively, not only is the support of the wall 8 of the casting mould 6 made possible, but rather a targeted heat dissipation or a targeted heat accumulation is also made possible. The support structure 9 can be suitable for ensuring that the heat dissipation is effectuated as quickly as possible. Due to an appropriate design, in particular due to closed hollow spaces, the heat dissipation is decelerated, however, since the closed hollow spaces 12 act as insulation more than the open hollow spaces 15.

Moreover, in the exemplary embodiment from FIG. 3, it is apparent that the support walls 13 have different wall thicknesses W. The support walls 13 that are arranged closer to the inner side 10 have a greater wall thickness W than the support walls 13 that are further away from the inner side 10 and are arranged closer to the outer side 11. This is indicated in FIG. 3 with the aid of different line thicknesses. With the aid of the different wall thicknesses W, it is possible that the support structure 9 is adjusted, in a highly targeted manner, to the required support effect and the desired heat dissipation. The wall thicknesses W of the support walls 13 can vary from preferably 0.1 mm up to several millimeters, for example, 5 mm or 6 mm. The entire wall 8 can have a thickness of several millimeters, for example, up to 75 mm. Very strong walls 8 are advantageous, in particular, if the wall 8 is to exert a particularly strong support effect or if the heat is to be retained in the cavity 5 for a very particularly long time.

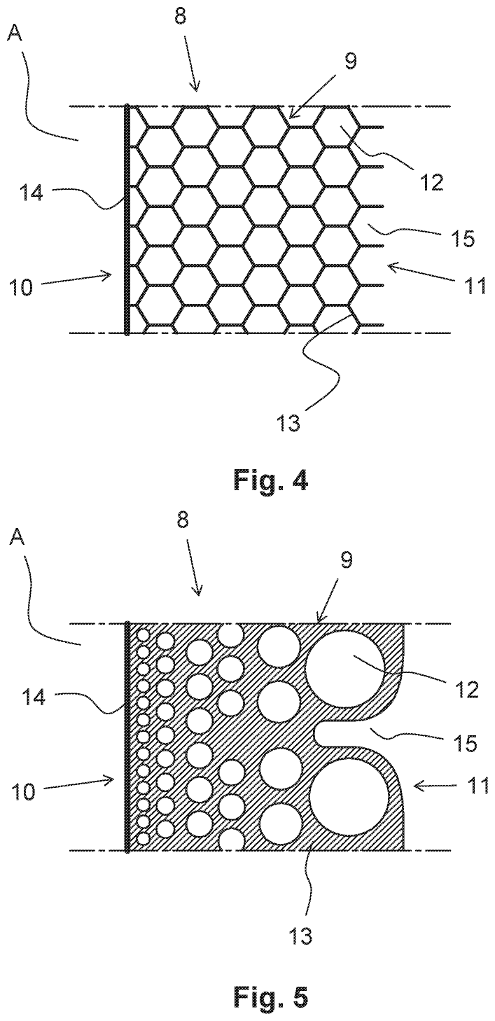

One further possibility of a design of a support structure 9 according to detail A from FIG. 1 is represented in FIG. 4. The support structure 9 comprises honeycomb-shaped hollow spaces 12 and 15 in this case. In addition to the closed hollow spaces 12, open hollow spaces 15 are also represented The open hollow spaces 15 face toward the outer side 11. At the inner wall 14 of the inner side 10, the honeycomb-shaped hollow spaces 12 are closed with the aid of the inner wall 14, and so a smooth surface of the inner side 10 arises, in order to obtain an appropriate surface of the cast part. The honeycomb-shaped support structure 9 is particularly stable and is simple to produce with the aid of the 3D printing method.

In FIG. 5, one further embodiment of the support structure 9 of the detail A is represented, in which the hollow spaces 12 have a circular cross section. They can be designed to be spherical or cylindrical. The support wall 13 has irregular thicknesses. It is located between the circular hollow spaces 12. The diameters of the circular hollow spaces 12 become greater from the inner side 10 toward the outer side 11. Of course, the arrangement can also be different, namely that hollow spaces 12 arranged in the area of the inner side 10 are larger than in the area of the outer side. This also applies for all remaining exemplary embodiments.

The inner side 10 is closed with the aid of the inner wall 14. The inner wall 14 can have a particularly low roughness. This is not necessary with respect to the support walls 13. In this case, an appropriately greater roughness can be selected, in particular when the production of the entire support structure 9 is to be implemented more quickly and simply as a result.

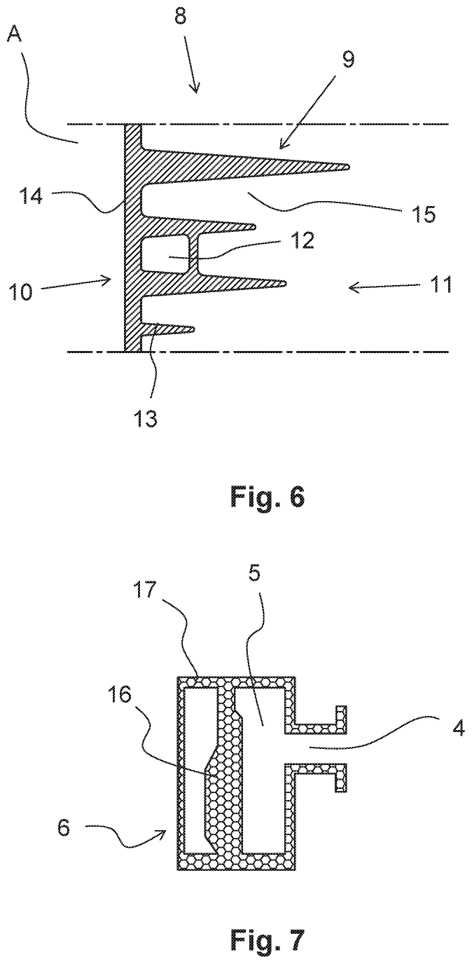

In FIG. 6, one further embodiment of the detail A comprising an appropriate support structure 9 is represented. The support structure 9 comprises support walls 13, which protrude from the inner wall 14 in the direction toward the outer side 11 in the manner of ribs. In this exemplary embodiment, the support walls 13 have decreasing wall thicknesses W, and so they are designed having a wedge-shaped cross section. This can facilitate the heat dissipation. In order to achieve good stability, closed hollow spaces 12 as well as open hollow spaces 15 can be provided. The closed hollow space 12 represented in this case has a trapezoidal cross section and comprises rounded corners. This improves the stability of the support structures 9 and demonstrates that a largely arbitrary design of the support structure 9 is possible, depending on the strength requirements or the requirements on the heat dissipation.

FIG. 7 shows an embodiment of the invention, in which the casting mould 6 comprises an inlet opening 4 into the cavity 5. A core 16 is arranged in the cavity 5. As represented here, the core 16 can be integrated into the casting mould 6, i.e., produced as one piece with a shell 17 of the casting mould 6. It can also be produced as a single part, however, and connected to the shell 17 of the casting mould 6. With the aid of the method according to the invention, the shell 17 can also be produced, as well as, alternatively, the core 16, or both the shell 17 and also the core 16.

The present invention is not limited to the represented and described exemplary embodiments. Modifications within the scope of the claims are also possible, as is any combination of the features, even if they are represented and described in different exemplary embodiments.

### LIST OF REFERENCE NUMERALS

1 gating system

2 pouring cup

3 downsprue

4 sprue

5 cavity

6 casting mould

7 shell mould

8 wall

9 support structure

10 inner side

11 hollow space

12 support wall

13 inner wall

14 hollow space

15 core

16 shell

17 A detail

18 W wall thickness

1. A method for producing a casting mould for filling with melt or a core for producing a cavity in a cast part, wherein the casting mould comprising a wall made of a refractory and gas-permeable material, wherein the method comprising the following steps:
forming a first layer of the wall, which has an inner surface and an outer surface opposite the inner surface, which defines a roughness matching the surface roughness of the part that is to be cast in the casting mould;
with the aid of a generative manufacturing method, forming a first successive layer against the first layer of the wall wherein the first successive layer includes a first successive support structure;
using a generative manufacturing method to form a plurality of further successive layers of the wall, wherein each further successive layer includes a further successive support structure, wherein each further successive layer is disposed against the immediately preceding further successive layer until are formed sufficient further successive layers to form the wall with sufficient further successive support structures especially designed for the casting mould and formed by open and/or closed hollow spaces in order to support the casting mould independently against the casting pressure in a dimensionally stable manner and also to specifically isolate thermal energy in the melt or dissipate thermal energy from the melt.

2. The method as in claim 1, wherein a 3D printing method is utilized as the generative manufacturing method, with the aid of which the casting mould is built up layer by layer and wherein at least one further successive layer includes an inner wall disposed against the further successive support structure of the immediately preceding further successive layer.

3. The method as in claim 1, wherein the generative manufacturing method is slurry-based, in particular carried out as stereolithography, using digital light processing technology (DLP), as direct inkjet writing (DIW), or using slipcasting-based technology.

4. The method as in claim 1, wherein the first layer of the wall includes an inner wall and the first successive support structure is arranged at the outer side of the inner wall and facing away from the future casting.

5. The method as in claim 1, wherein each further successive support structure is designed to be coarser in comprising larger open and/or closed hollow spaces when moving in a direction from the inner surface of the first layer of the wall facing the future casting toward an outer side of the wall that is facing away from the future casting.

6. The method as in claim 1, wherein multiple identical or different casting moulds are connected to to form a gating system in an aciniform manner.

7. The method as in claim 1, wherein a surface structure having a very low roughness (R_{z}<100 μm) is formed at the inner side surface of the first layer of the wall of the casting mould.

8. The method as in claim 1, wherein the casting mould is produced for a precision casting method.

9. The method as in claim 1, wherein the casting mould is utilized for a single-crystal casting.

10. (canceled)

11. A casting mould for filling with melt under a casting pressure, the casting mould comprising:
a wall made of a refractory and gas-permeable material, wherein the wall is built up with the aid of a generative manufacturing method, wherein the wall comprises a support structure formed by open and/or closed hollow spaces and/or different wall thicknesses, in order to support the casting mould independently against the casting pressure in a dimensionally stable manner and also to specifically isolate thermal energy in the melt or dissipate thermal energy from the melt in a targeted manner.

12. The casting mould as in claim 11, wherein the casting mould is a precision casting mould.

13. The casting mould as in claim 11, wherein the wall comprises an inner side facing the future cast part and an outer side facing away from the future cast part, wherein a negative mould of a cast part to be cast is formed at the inner side of the wall and the support structure is arranged at the outer side of the wall].

14. The casting mould as in claim 11, wherein multiple identical or different casting moulds are connected to form a gating system in an aciniform manner.

15. The casting mould as in claim 11, wherein the casting mould is built up layer by layer with the aid of 3D printing.

16. The casting mould as in claim 11, wherein the support structure is designed to be coarser when moving in a direction from the inner side toward the outer side of wall in comprising increasingly larger hollow spaces when moving in a direction from the inner side toward the outer side of the wall.

17. The casting mould as in claim 16, wherein the hollow spaces are rounded and/or angular and/or in the shape of pores, honeycombs, and or cuboids.

18. The casting mould as in claim 11, wherein the support structure is formed comprising wall thicknesses that become thinner from the inner side toward the outer side of the wall.

19. The casting mould wherein a surface structure having a very low roughness (R_{z}<100 μm) is formed at the inner side of the wall.

20. The casting mould wherein the wall thickness of the support structure is between 0.1 mm and 75 mm.

21. The casting mould as in claim 11, wherein the casting mould is a single-crystal casting mould.

22. (canceled)
